(19) United States
(12) Patent Application Publication
(10) Pub. No.: US 2014/0305741 A1
(43) Pub. Date: Oct. 16, 2014

(54) LOAD HANDLING ASSEMBLY AND METHOD

(71) Applicant: LOADHOG LIMITED, South Yorkshire (GB)

(72) Inventors: Leigh Jowett, Sheffield (GB); Edward John Peter Stubbs, Sheffield (GB); Thomas Spotswood, Doncaster (GB)

(73) Assignee: LOADHOG LIMITED, Sheffield, South Yorkshire (GB)

(21) Appl. No.: 14/356,290

(22) PCT Filed: Nov. 1, 2012
(86) PCT No.: PCT/GB2012/000820

§ 371 Date: May 5, 2014

(30) Foreign Application Priority Data
Nov. 4, 2011 (DE) 1119026.1
Mar. 28, 2012 (DE) 1205412.8
Oct. 30, 2012 (DE) 1219446.0

(51) Int. Cl. B66F 9/20

(52) U.S. Cl. CPC B66F 9/20
USPC 187/233; 414/801

(57) ABSTRACT

A method of handling a load comprising a plurality of articles (100) is disclosed. The method comprises providing a lifting assembly (10) comprising a plurality of carrying arrangements (12) arranged one above another. The carrying arrangements are movable between proximate and separated conditions, whereby adjacent carrying arrangements are spaced from each other by a greater distance in the separated condition than in the proximate condition. The method further includes disposing the articles on the carrying arrangements when the carrying arrangements are in the proximate condition, and moving the carrying arrangements to the separated condition, thereby moving the articles to a spaced configuration. With the carrying arrangements in the separated condition, the method includes delivering the articles to a support assembly (104) to dispose the articles at the support assembly in the spaced configuration.

This invention relates to load handling assemblies. This invention also relates to methods of handling loads. More particularly, but not exclusively, this invention relates to lifting assemblies and methods for use in moving articles to treatment areas, such as freezers. Embodiments of the invention relate to lifting assemblies for moving products, for example meat products, such as bacon, to racks, such as in freezers.

In the food processing industry, food products, such as meat, which may be bacon logs or sides of bacon, are stacked during transport and freezing in large pallet boxes. The weight of the stacked products causes them to be compressed, thereby squeezing out fluids. This is undesirable to the customer. Moreover, the close packing of the products means that it needs to be moved by hand to shelved racks in the freezers to allow air to circulate around the products and thereby provide the necessary freezing efficiency.

According to a first aspect of this invention, there is provided a method of handling a load comprising a plurality of articles, wherein the method comprises: providing a lifting assembly comprising a plurality of carrying arrangements arranged one above another, the carrying arrangements being movable between proximate and separated conditions, whereby adjacent carrying arrangements are spaced from each other by a greater distance in the separated condition than in the proximate condition; disposing the articles on the carrying arrangements when the carrying arrangements are in the proximate condition; moving the carrying arrangements to the separated condition, thereby moving the articles to a spaced configuration; and, with the carrying arrangements in the separated condition, delivering the articles to a support assembly to dispose the articles on the support assembly in the spaced configuration.

The step of moving the carrying arrangements to the separated condition may comprise sequentially raising at least some of the carrying arrangements. The support assembly may be provided in a treatment assembly.

The method may include a treatment step after the articles have been disposed on the support assembly. The treatment step may comprise freezing the products on the articles.

The treatment assembly may be a freezing assembly to effect freezing of the articles and of products, for example food products, held on the articles. The food products may be meat products, such as logs or sides of bacon. Where the articles comprise trays for holding products, the trays may define a plurality of air flow apertures. The embodiment of the lifting assembly described herein provides the advantage that, when the carrying arrangements are in the separated condition, the spacing of the articles thereon allows air to flow efficiently through the air flow apertures. This provides for efficient freezing, where the treatment assembly comprises a freezing assembly. The ability to effect efficient freezing by the preferred embodiment provides a further advantage that the meat products have a consistent temperature at their core, thereby facilitating consistency of slicing,

The support assembly may comprise a rack. The support assembly may be disposed within the freezing assembly.

The support assembly may have a plurality of support arrangements, which may be disposed one above another. Each support arrangement is preferably spaced from the, or each, adjacent support arrangement by a distance which is substantially equal to the distance between adjacent carrying arrangements when the carrying arrangements are in the separated condition.

The step of disposing the articles at the support assembly may comprise presenting the lifting assembly to the support assembly, and moving the lifting assembly to insert each carrying arrangement between adjacent support arrangements of the support assembly. The method may further include lowering the carrying arrangements to dispose the articles onto respective support arrangements.

The method may comprise withdrawing the lifting assembly from the rack, after the aforesaid step of lowering the carrying arrangements.

The method may include removing the articles from the support assembly by inserting respective carrying arrangements between adjacent support arrangements.

When the carrying arrangements are inserted between adjacent support arrangements, the carrying arrangements may be in the separated condition.

The articles may be disposed on the carrying arrangements, conveniently by moving the carrying arrangements upwardly relative to the support arrangements, thereby lifting the articles. The method may thereafter include removing the articles from the treatment assembly.

The step of removing the articles from the support assembly may include moving the carrying arrangements from the separated condition to the proximate condition. The step of moving the carrying arrangements from the separated condition to the proximate condition may comprise sequentially lowering at least some of the carrying arrangements.

The method may include delivering the articles to a receiving means and disposing the articles at said receiving means with the carrying arrangements in said proximate condition in a stacked configuration. The step of disposing the articles at said receiving means may comprise lowering the carrying arrangements.

According to a second aspect of this invention, there is provided a method of handling a load comprising a plurality of articles, wherein the method comprises: providing a lifting assembly comprising a plurality of carrying arrangements arranged one above another, the carrying arrangements being movable between proximate and separated conditions, whereby adjacent carrying arrangements are spaced from each other by a greater distance in the separated condition than in the proximate condition; providing a plurality of articles in a spaced configuration on a support assembly; and with the carrying arrangements in the separated condition, disposing the articles on the carrying arrangements; removing the articles from the support assembly; delivering the articles to a receiving means; and moving the carrying arrangements to the proximate condition to dispose the articles on the receiving means.

The support assembly may have a plurality of support arrangements disposed one above another. Each support arrangement may be spaced from the, or each, adjacent support arrangement by a distance which is substantially equal to the distance between adjacent carrying arrangements when the carrying arrangements are in the separated condition. The method may include inserting respective carrying arrangements between adjacent support arrangements.

After said carrying arrangements have been inserted between adjacent support arrangements, the articles may be disposed on the carrying arrangements by moving the carrying arrangements upwardly relative to the support arrangements, thereby lifting the articles.

The step of removing the articles from the support assembly may be effected after the articles have been lifted from the support arrangements. The step of moving the carrying arrangements from the separated condition to the proximate condition may comprise sequentially lowering at least some of the carrying arrangements.

The step of disposing the articles on said receiving means may comprise arranging said articles in a stacked configuration.

According to a third aspect of this invention, there is provided a lifting assembly comprising a plurality of carrying arrangements arranged one above another, the carrying arrangements being movable between proximate and separated conditions, whereby adjacent carrying arrangements are spaced from each other by a greater distance in the separated condition than in the proximate condition.

The lifting assembly may further include lifting means for applying a lifting force to the carrying arrangements to lift the carrying arrangements, and a transmission arrangement for transmitting the lifting force to each of the carrying arrangements to move the carrying arrangements between the proximate and the separated conditions.

According to a fourth aspect of this invention, there is provided a method of lifting a plurality of articles comprising providing a lifting assembly as described above, arranging an article on each carrying arrangement, lifting a first of the carrying arrangements to cause the transmission arrangement to lift the, or each, other carrying arrangement, thereby moving the carrying arrangements to the separated condition and lifting the articles.

The method of handling a load, the method of lifting a plurality of articles, and the lifting assembly are particularly suitable for use in the meat processing industry and can be used for the movement of bacon logs or sides of bacon into freezers in an efficient and cost effective way. The method and the lifting assembly are particularly suitable for use with trays described below.

The embodiments described herein provide the advantage that, where the articles are in the form of trays holding produce for freezing, e.g. bacon logs or sides of bacon, the produce is not compressed and, consequently, not damaged. A further advantage of the embodiments described herein is that fluids are not squeezed out of the produce during storage. The aforesaid embodiments also provide the advantage that the handling of the produce by mechanical means is more efficient than the prior art manual handling methods.

The transmission arrangement may comprise a plurality of transmission means. Each transmission means may be connected to adjacent carrying arrangements. Each transmission means may comprise a first transmitting member connected to a first of the adjacent carrying arrangements, and a second transmitting member connected to a second of the adjacent carrying arrangements.

Each transmission means may be movable between a non-transmitting position, in which the adjacent carrying arrangements are in their proximate condition, and a transmitting position, in which the adjacent carrying arrangements are in their separated condition. In the transmitting position, each transmitting means can transmit the lifting force from one of the adjacent carrying arrangements to the other of the adjacent carrying arrangements, desirably from the upper of the adjacent carrying arrangements to the lower of the adjacent carrying arrangements.

In a first embodiment, each first transmitting member may be pivotally connected to the first of the adjacent carrying arrangements, and each second transmitting member may be pivotally connected to the second of the adjacent carrying arrangements. The first and second transmitting members may be pivotally connected to each other.

In the first embodiment, the first and second transmitting members may be movable between flexed and extended positions. When the adjacent carrying arrangements are in the proximate condition, the first and second transmitting members may be in the flexed condition. When the adjacent carrying arrangements are in the separated condition, the first and second transmitting members may be in the extended position.

In a second embodiment, the first and second transmitting members of each transmission arrangement may be slidable relative to each other. In the second embodiment, each first transmitting member may comprise a pulling member connected to the first carrying arrangement.

The first transmitting member may include an engaging member on the pulling member for engaging the second transmitting member and applying the lifting force thereto. The engaging member may comprise an outwardly extending member, which may be a radially outwardly extending member.

The engaging member may comprise a washer. The first transmitting member may further include a fastener for fastening the engaging member to the pulling member. The fastening member may comprise a screw or bolt.

The second transmitting member may comprise a reaction member, which can be engaged by the engaging member. The reaction member may define an aperture through which the pulling member extends. The engaging member may engage the reaction member to apply said lifting force thereto when the transmission means is moved from non-transmitting position to the transmitting position.

The lifting assembly may comprise a support for supporting the carrying arrangements. The support may comprise an upstanding elongate member. The plurality of carrying arrangements may comprise bearing means to engage the support.

In the first embodiment, the bearing means may comprise roller bearings to engage the support. The bearing means may comprise two sets of opposed roller bearings to engage the support opposite each other. Each carrying arrangement may have two opposed bearing members arranged to engage the support opposite each other.

In the second embodiment, the support means may comprise a rail, along which the carrying arrangements may slide.

The lifting means may comprise hydraulic lifting means, such as at least one hydraulic ram.

Each carrying arrangement may comprise two carrying members. Each carrying member may have a substantially L-shaped profile.

The lifting assembly may comprise two arrays of the carrying members, each array comprising a plurality of the carrying members movable between the proximate and separated conditions. The carrying members of each array may be arranged substantially vertically, one above another. The lifting means may apply the lifting force to both arrays.

The arrays may be arranged side by side to provide a plurality of pairs of carrying members, wherein the carrying members of each pair are disposed to carry a respective article between them. Each pair of carrying members may constitute a respective one of the carrying arrangements.

According to a fifth aspect of this invention, there is provided a tray comprising a main body having a plurality of holding formations for holding a plurality of products, the main body defining an air flow path between adjacent holding formations, wherein each holding formation comprises first and second wall portions arranged opposite each other, the first wall portion defining an aperture allowing communication between the air flow path and a region above the tray, to allow a flow of air across the products.

Each product may comprise a food product, such as a meat product. Each meat product may comprise a log or side of bacon.

The preferred embodiment of the tray is particularly suitable for use in the method of handling a load, and with the lifting assembly and method of lifting described above.

Each holding formation may include a lower portion from which the wall portions extend. Each holding formation may define a plurality of apertures allowing communication between a region below the tray and a region extending over the tray.

In the preferred embodiment of the tray, the apertures allow air flow around the products. The apertures provide the advantage in the preferred embodiment, as described above, that when the tray is used in the method of handling a load, air can flow around the products, when the carrying arrangements are in the separated condition.

Each holding formation may have a generally U-shaped profile. The lower portion and the first and second wall portions may merge into one another. The first wall portion may extend from the lower portion less steeply than the second wall portion.

The air paths may be defined between the first wall portion of one holding formation and the second wall portion of the adjacent holding formation.

When the tray is in a first orientation relative to a further tray, the tray may be arranged in a stacked condition on the further tray. When the tray is in a second orientation relative to a further tray, the tray may be arranged in a nested condition on the further tray.

The tray may comprise a plurality of support formations to engage the further tray when the tray is arranged on the further tray in the stacked condition. The plurality of support formations may support the tray on the further tray. The support formations may be configured to engage a support formation of a treatment or storage rack.

The tray may define a plurality of receiving formations to receive support formations of a further tray disposed on the tray in the nested condition. The support formations of the tray may be configured to be received by the receiving formations of another tray on which the tray is arranged in the nested condition.

The tray may include a rim extending around the main body. The support formations may extend downwardly from the rim. The receiving formations may be defined in the rim. The receiving formations may be apertures defined in the rim.

A respective locating member may be provided on the rim above each support formation to locate a further tray on the tray in the stacked condition. The support formations of the further tray may be disposed over the locating members on the tray when the further tray is located on the tray in the stacked condition. The locating members of the tray may be received in the support formations of the further tray when the further tray is located on the tray in the stacked condition.

The locating members and the receiving formations may be arranged on the rim so that each support formation is aligned with a support formation of a further tray when the further tray is located on the tray in the stacked condition. The locating member and the receiving formations may be arranged so that each support formation of the tray is aligned with a receiving formation of a further tray when the tray and the further tray are arranged in the nested condition.

Embodiments of the invention will now be described by way of example only, with reference to the accompanying drawings, in which:

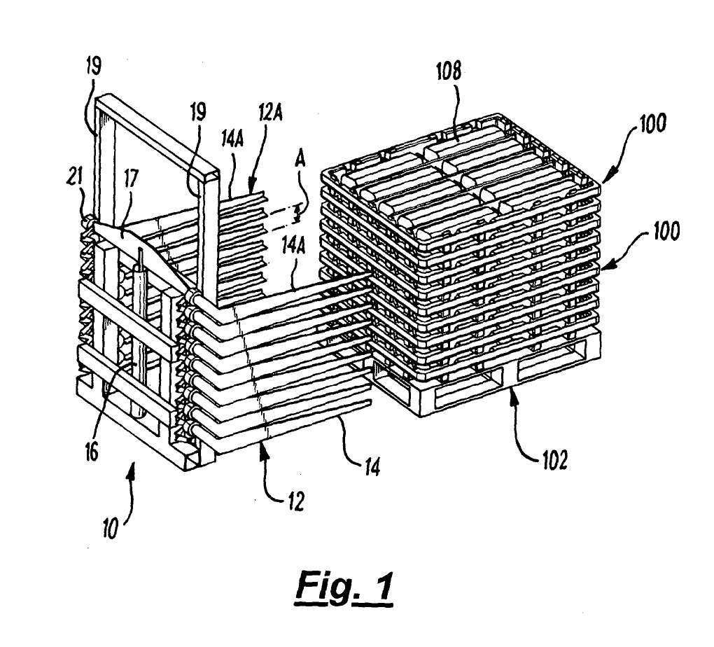

FIG. 1 is a perspective view of a lifting assembly, and a plurality of articles to be lifted;

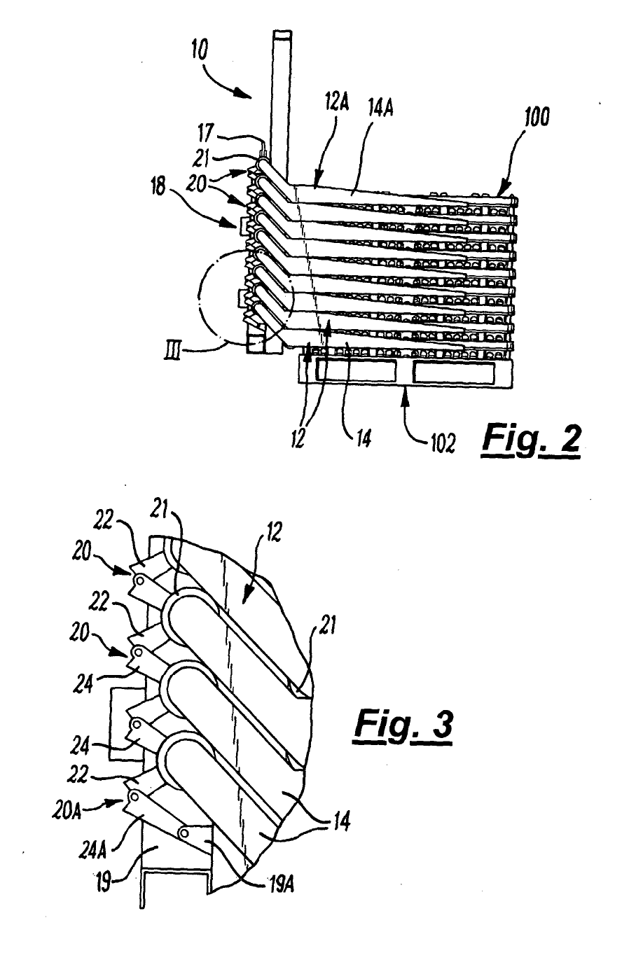

FIG. 2 is a side view of the lifting assembly and the articles shown in FIG. 1, with the lifting assembly in a position to lift the articles;

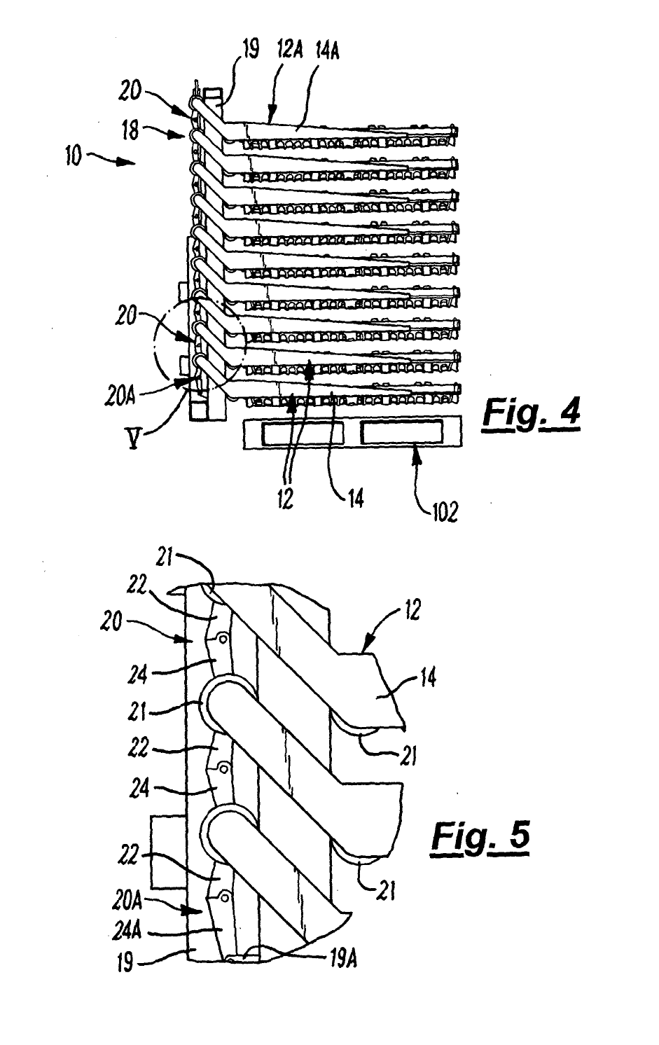

FIG. 3 is a close-up view of the region marked Ill in FIG. 2;

FIG. 4 shows the lifting assembly lifting the articles;

FIG. 5 is a close-up view of the region marked V in FIG. 4;

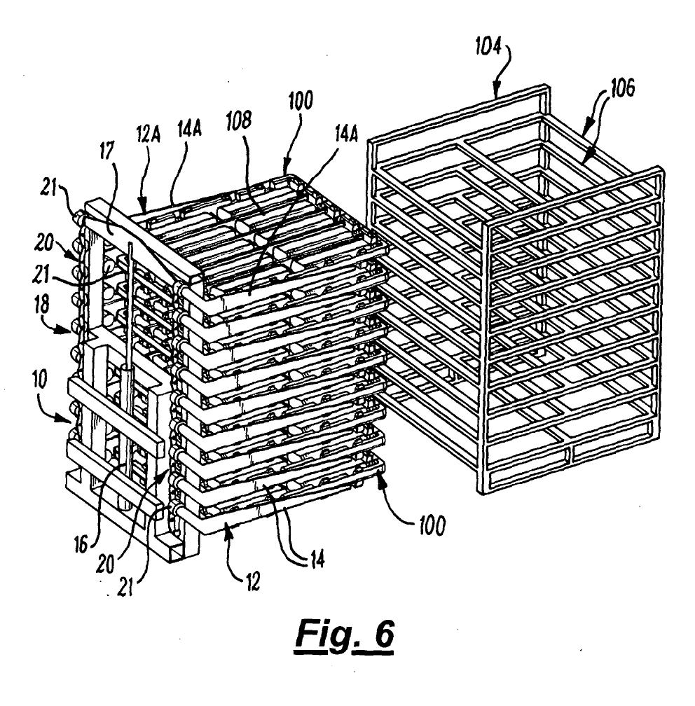

FIG. 6 is a perspective view of the lifting assembly moving the articles to a support assembly;

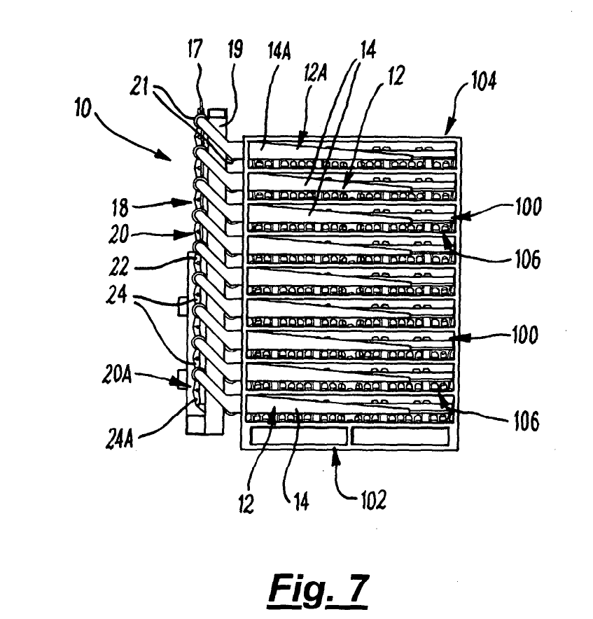

FIG. 7 is a side view showing the lifting assembly disposing the articles on the support assembly;

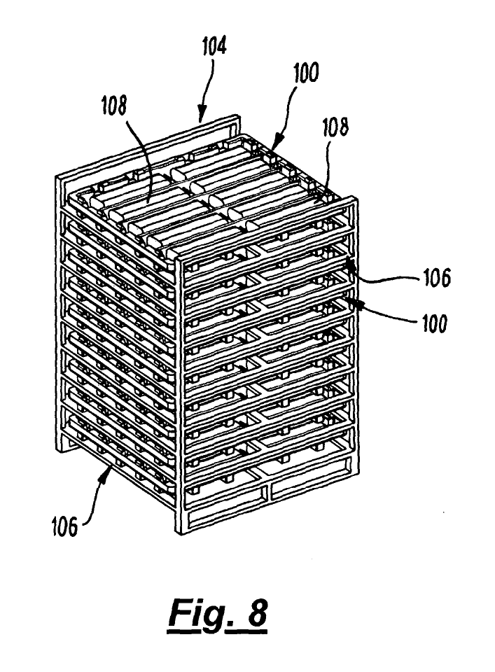

FIG. 8 shows the articles on the support assembly;

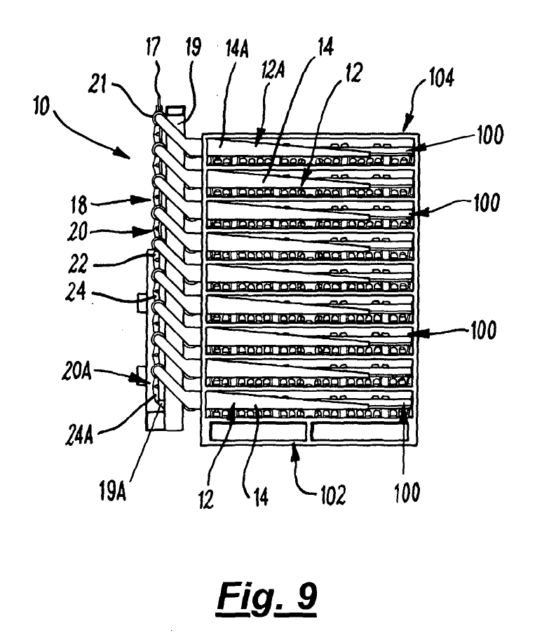

FIG. 9 is a side view showing the lifting assembly about to lift the articles from the support assembly;

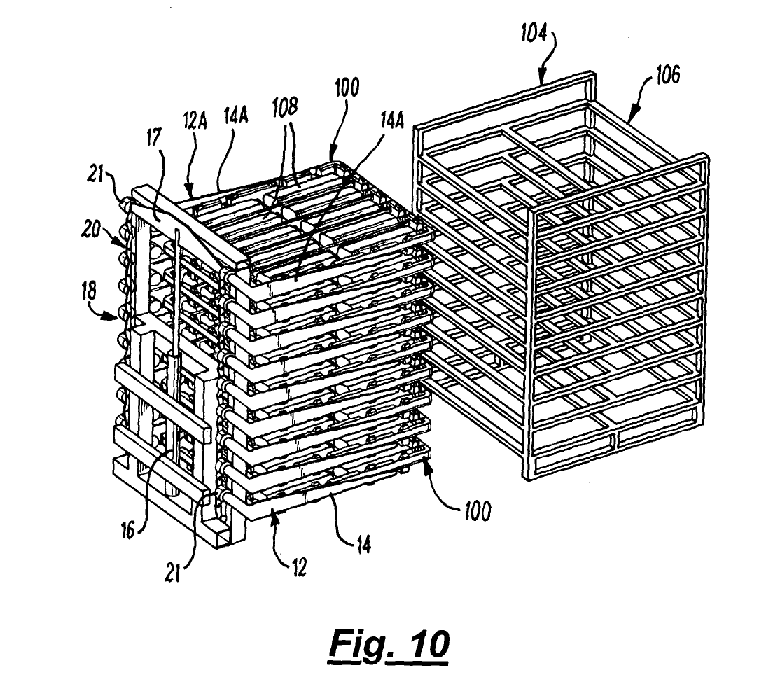

FIG. 10 is a perspective view of the lifting assembly removing the articles from the support assembly;

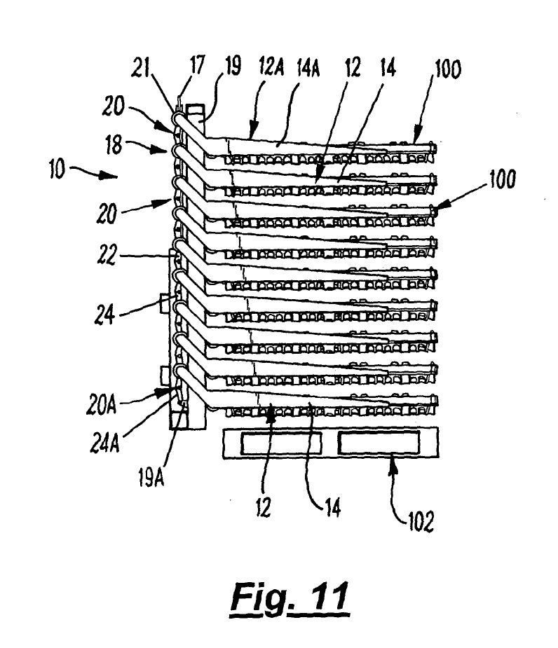

FIG. 11 shows the lifting assembly arranging the removed articles over a receiving means;

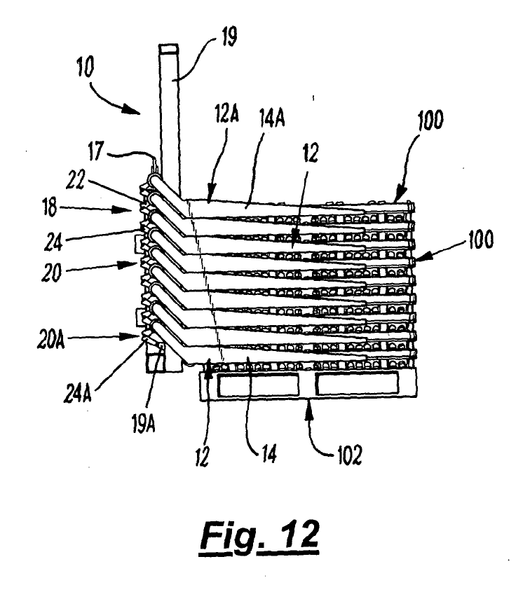

FIG. 12 is a side view of the lifting assembly disposing the articles on the receiving means;

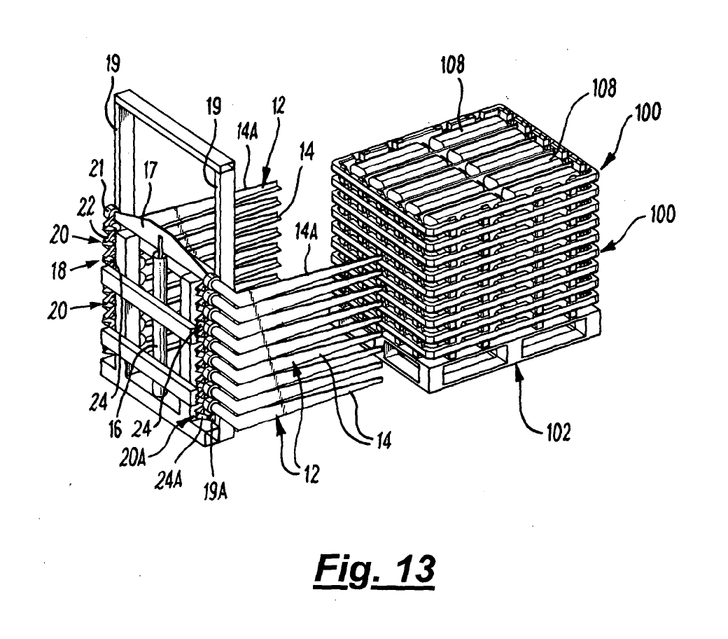

FIG. 13 is a perspective view of a lifting assembly moving away from the receiving means after disposing the articles thereon;

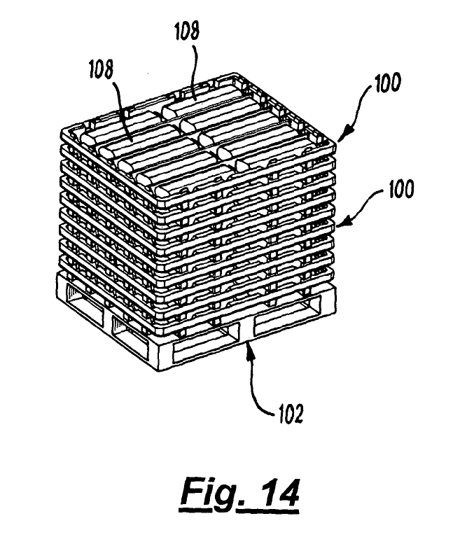

FIG. 14 shows the articles stacked on the receiving means

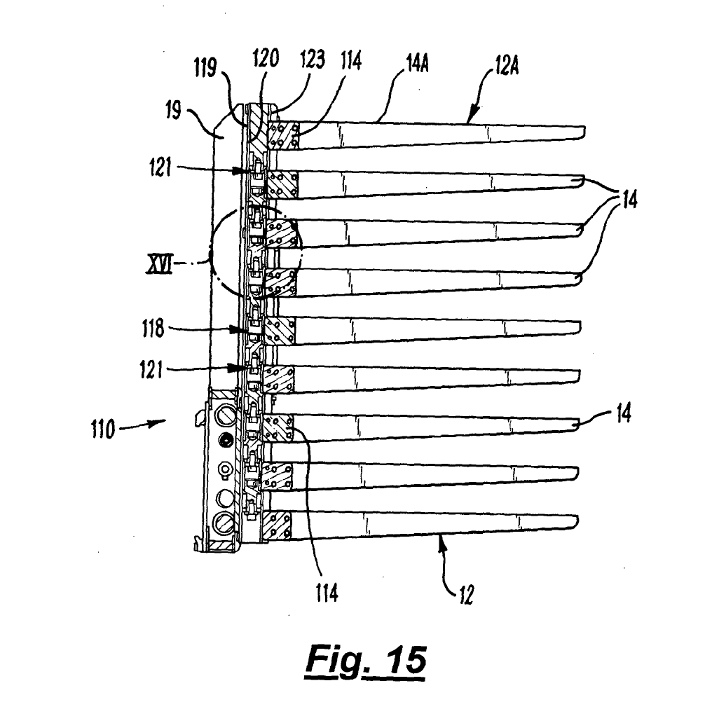

FIG. 15 is a sectional side view of another embodiment of a lifting assembly;

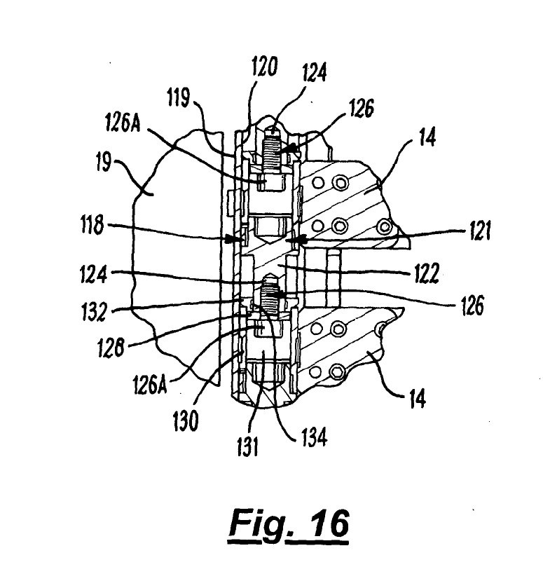

FIG. 16 is a close-up view of the region marked XVI in FIG. 15;

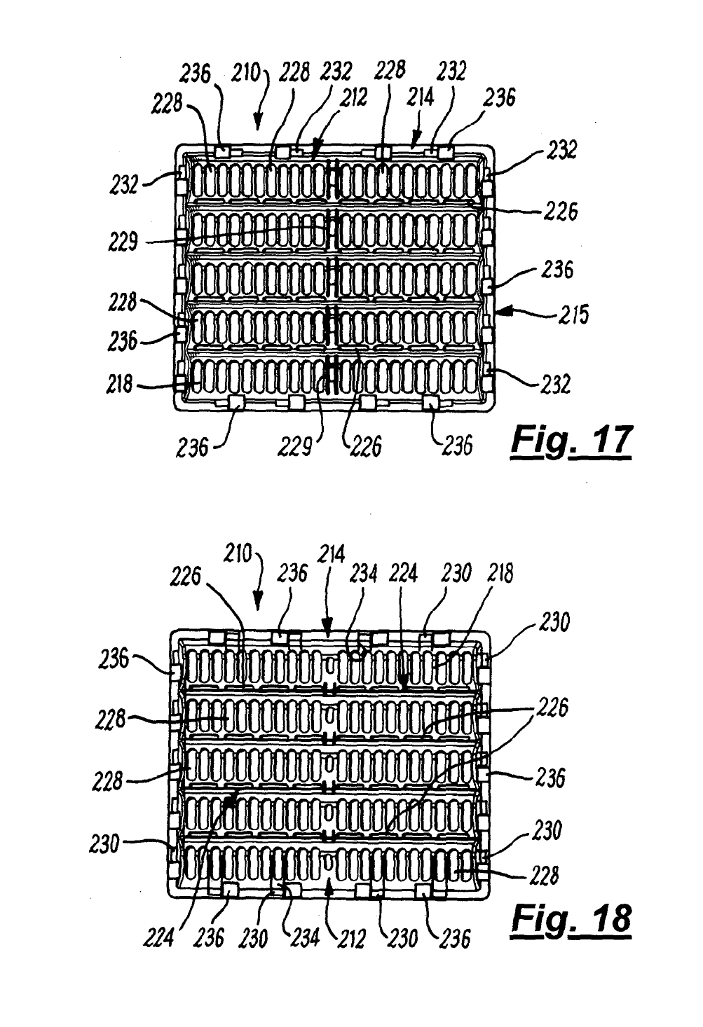

FIG. 17 is a top plan view of a tray;

FIG. 18 is a bottom plan view of the tray;

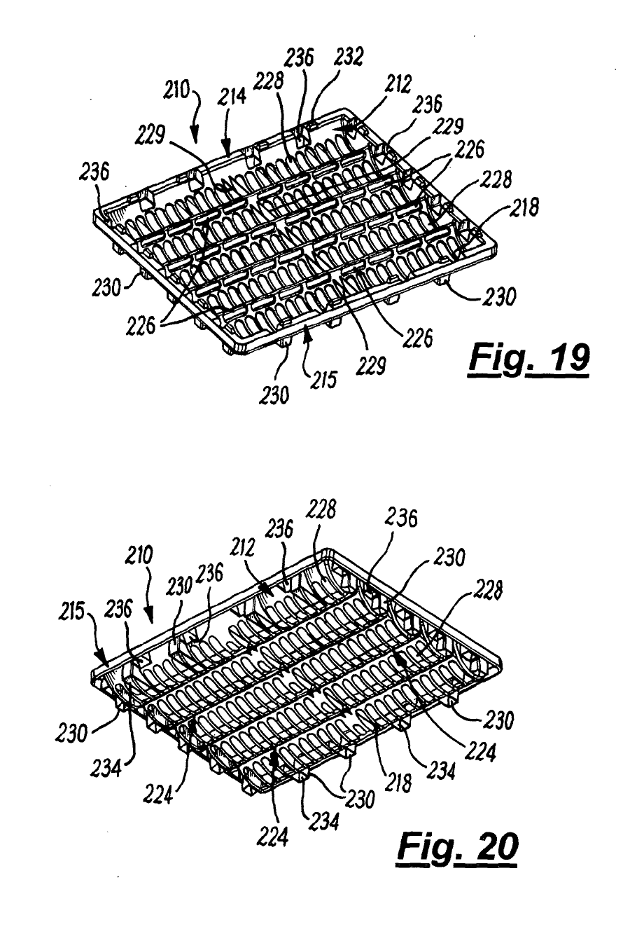

FIG. 19 is a top perspective view of the tray;

FIG. 20 is a bottom perspective view of the tray;

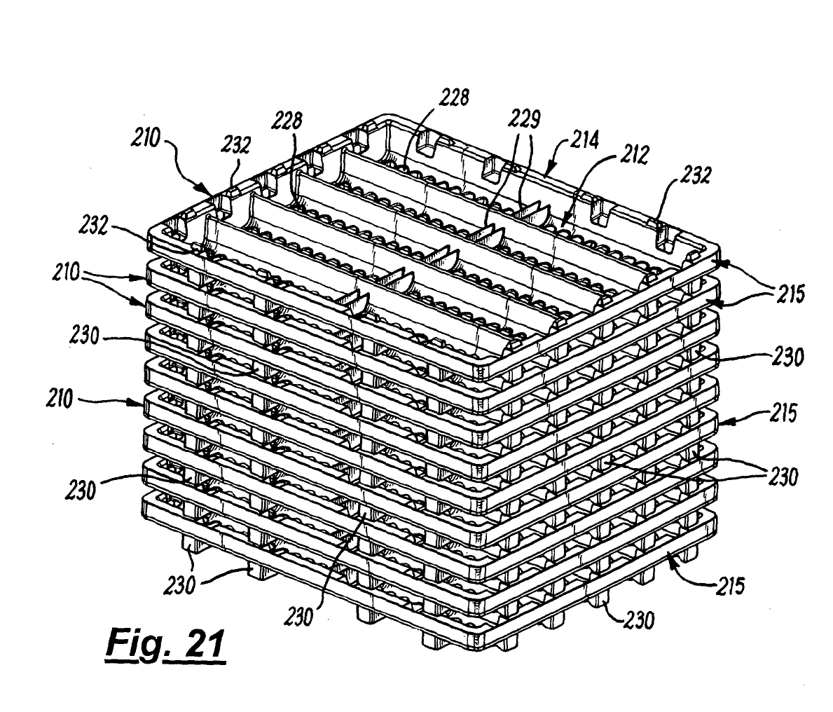

FIG. 21 is a perspective view of a plurality of the trays in a stacked condition;

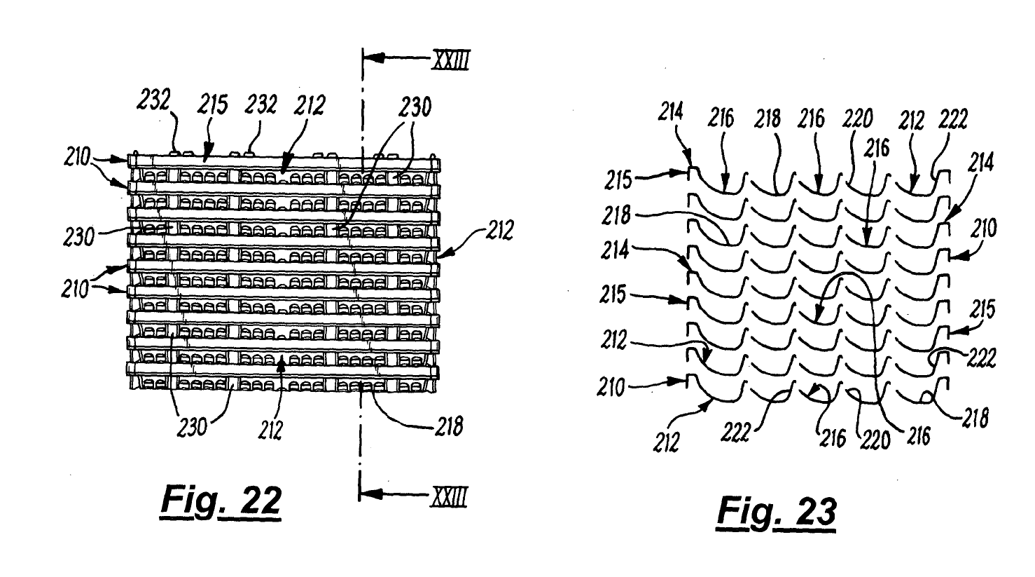

FIG. 22 is a side view of the stack of trays shown in FIG. 21;

FIG. 23 is a view along the lines XXIII-XXIII of the stack of trays shown in FIG. 22;

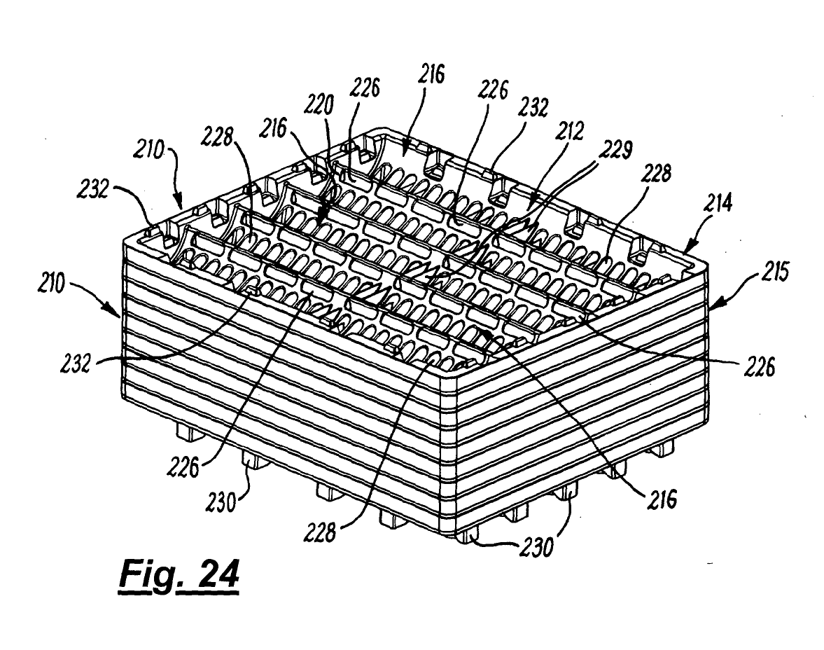

FIG. 24 is a perspective view of a plurality of the trays in a nested condition;

FIG. 25 is a side view of the trays in the nest condition; and

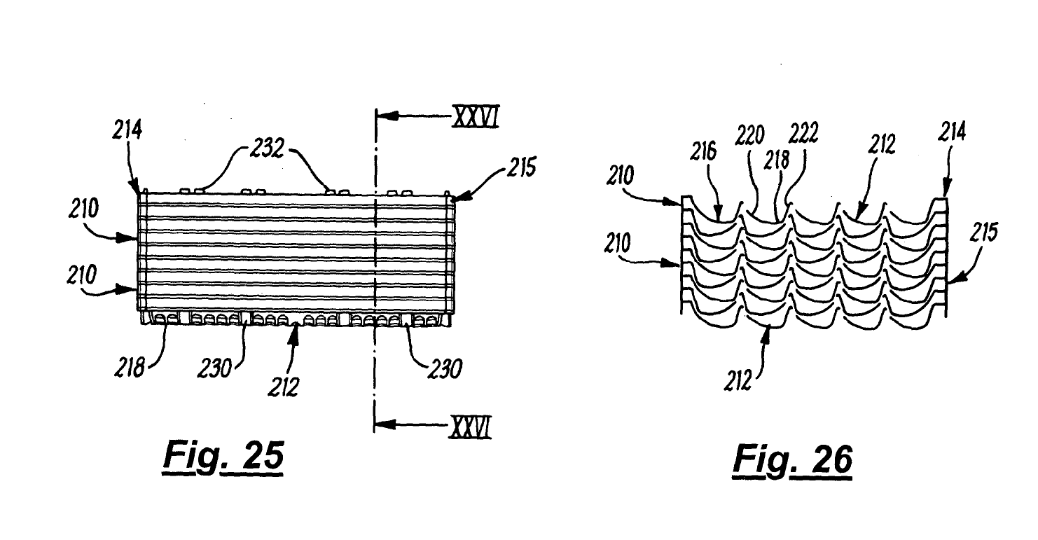

FIG. 26 is a view along the lines XXVI-XXVI shown in FIG. 25.

FIGS. 1 to 14 of the drawings show a lifting assembly 10 for use in moving articles in the form of trays 100 from a pallet 102 to a support assembly in the form of a rack 104 in a treatment assembly comprising the rack 104 and a freezer. In the embodiment described herein, the rack 104 is a freezer rack disposed within the freezer, and the trays 100 are suitable for holding products 108, such as meat products, for example in the form of bacon logs or sides of bacon.

The lifting assembly 10 comprises a plurality of carrying arrangements 12, each comprising a pair of carrying members 14. The carrying arrangements 12 are arranged sequentially one above another. The lifting assembly 10 is provided to lift the trays 100 stacked on the pallet 102. The lifting assembly is mounted on a suitable vehicle (not shown), to allow it to be moved about. The vehicle can be a fork lift truck.

In the arrangement shown in FIG. 1, the carrying members 14 are in a proximate condition, in which adjacent carrying members 14 of each carrying arrangement 12 are closely spaced from each other by a first distance A. The carrying arrangements 12 and, hence, the carrying members 14 can be lifted from the proximate condition to a separated condition shown in FIG. 4 and described in more detail below.

The lifting assembly 10 further includes lifting means 16, in the form of an hydraulic ram. The lifting means 16 provides a lifting force to lift the carrying arrangements 12. A connecting member 17 is connected to, and extends between, the uppermost carrying members, designated 14A, of the uppermost carrying arrangements 12A. The lifting means 16 is connected to the connecting member 17, thus lifting the carrying arrangements 12, and thereby lifting the carrying members 14.

The lifting assembly 10 also has a transmission arrangement 18 for transmitting the force from the lifting means to the carrying members 14 and lifting the carrying members 14 to the separated condition.

The carrying members 14 are in the form of tines, and are supported on elongate upstanding rectangular section supports 19. Each carrying member has a pair of opposed bearing members 21 which engage opposite faces of the supports 19.

The transmission arrangement 18 comprises a plurality of transmission means 20, wherein each transmission means 20 is connected between the adjacent carrying members 14 of adjacent carrying arrangements 12.

Referring to FIG. 2, the lifting assembly 10 is moved to a position where the carrying members 14 are inserted between the trays 100 so that the trays 100 can be lifted.

Referring to FIG. 3, which shows the region marked III in FIG. 2, each transmission means 20 comprises a first upper transmitting member 22 which is pivotally connected to the upper carrying member 14 of the two adjacent carrying members 14. Each transmission means 20 also has a second lower transmitting member 24 which is pivotally connected to the lower of the two adjacent carrying members 14. The first and second transmitting members 22, 24 of each transmission means 20 are pivotally connected to each other.

The lowermost transmission means is designated 20A in FIGS. 3 and 5. The lower transmitting member thereof is designated 24A in FIGS. 3 and 5, and is pivotally connected to the support 19 at a lug 19A.

In FIGS. 1 to 3, the carrying members 14 are in their proximate condition, as explained above. When the carrying members 14 are in the proximate condition, each transmission means 20 is in a non-transmitting position, and the transmitting members 22, 24 of each transmission means 20 are in a flexed position, as shown in FIG. 3.

In FIG. 4, the carrying members 14 are lifted sequentially to their separated condition by the lifting means 16. As can be seen from FIG. 4, in the separated condition, the carrying members 14 are spaced from each other by a second distance B, which is greater than the distance A, i.e. in the separated condition shown in FIG. 4, the carrying members 14 are spaced further from each other than in the proximate condition shown in FIGS. 1 and 2.

The lifting of the carrying members 14 to the separated condition is effected by the transmission arrangement 20. When the lifting means 16 applies the lifting force to the connecting member 17, the uppermost carrying members 14A are lifted. This lifting of the uppermost carrying member 14A causes the transmission means 20 connected thereto to move to its transmitting position, so that the first and second transmitting members 22, 24 pivot to their extended position.

Further lifting of the uppermost carrying member 14A by the lifting means 16 causes the lifting force to be transmitted by the transmitting members 22, 24 to the carrying member 14 directly beneath the uppermost carrying member 14A.

As the lifting means continues to lift the uppermost carrying member 14A, the lifting force is transmitted by each of the transmission means 20 in turn, as the transmitting members 22, 24 of each transmission means 20 are moved to their extended condition. This continues until all of the carrying members 14 have been lifted to the position shown in FIG. 4.

FIG. 5 shows a close up of the region marked V in FIG. 4, in which the transmitting members 22, 24 of three of the transmission means 20 are shown in their extended conditions.

FIG. 6 shows the trays 100 being moved by the lifting assembly 10 to a rack 104, which has a plurality of support arrangements 106 spaced one above another. The support arrangements 106 are spaced from adjacent support arrangements by a distance that is substantially equal to the distance between adjacent carrying members 14 in their separated condition.

FIG. 7 shows the lifting assembly 10 inserting a respective one of the carrying arrangements 12 between adjacent support arrangements 106, thereby inserting each of the trays 100 into the rack 104, so that each tray is disposed above a respective one of the support arrangements 106. The lifting means 16 can then lower the carrying members 14 so that each tray 100 is disposed on the respective support arrangement 106. The lifting assembly 10 can then be withdrawn from the rack 106, by reversing the vehicle, and the carrying arrangements 12 can be lowered to their proximate condition shown in FIG. 1 by lowering the lifting means 16.

FIG. 8 shows the loaded rack 104. The trays 100 are supported on the support arrangements 106, and are thus spaced from each other by the spacing between the adjacent support arrangements 106. The spacing of the trays 100 is required in order to ensure fast and efficient freezing of the products 108.

After freezing, the trays 100 are removed from the rack 104 and disposed on a receiving means, in the form of a pallet, such as a further pallet 102. The further pallet 102 may be disposed in a freezer part of a lorry trailer or in a freezer wagon of a train. The removal of the trays 100 from the rack 104 is effected by carrying out the above described steps in reverse.

The removal of the trays 100 from the rack 104, and subsequent disposal on the further pallet 102 is described below, with reference to FIGS. 9 to 13.

When the freezing is completed, it is necessary to remove the trays 100 from the freezer for further processing or transport. The lifting assembly 10 is moved to the position shown in FIG. 9. The carrying members 14 are in their separated condition, and are inserted between adjacent support arrangements 106 of the rack 104.

The carrying arrangements 12 are then lifted to raise the trays 100 from the support arrangements 106, and the lifting assembly 10 is then reversed to the position shown in FIG. 10, in which the trays 100 are removed from the rack 104. The lifting assembly 10 is then moved to the position shown in FIG. 11, in which the carrying arrangements 12 and the trays 100 are disposed over a pallet 102.

The connecting member 17 is then lowered, thereby lowering all the carrying arrangements 12. The lowermost tray 100 engages the pallet 102 and on continued lowering of the connecting member 17, the lowermost carrying members 14 engage the tray.

Thereafter, on further lowering of the connecting member 17 and, thereby, the carrying arrangements 12, the trays 100 are sequentially lowered onto one another, until they are arranged in a stacked condition on the pallet 102. The carrying members 14 are lowered until they are arranged in the proximate condition.

As a result of this lowering, the lifting assembly 10 and the trays 100 are arranged as shown in FIG. 12. The lifting assembly is then retracted from the stacked trays 100, as shown in FIG. 13. The trays 100 stacked on the pallet 102 are shown in FIG. 14.

The pallet 102 shown in FIGS. 11 to 14 may be in the freezer part of a lorry trailer or in the freezer wagon of a train, so that the trays 100 can be transported to a desired destination with the products 108 in a frozen condition.

Various modifications to the lifting apparatus 10 can be made without departing from the scope of the invention. An example of such a modification is shown in FIGS. 15 and 16. In a further modification, the treatment assembly may be any other suitable assembly for treating articles, where it is desirable that they are spaced from one another, such as an oven.

The lifting assembly shown in FIGS. 15 and 16 is generally designated 110, and includes many of the same features as the embodiment shown in FIGS. 1 to 14.

These features have been designated with the same reference numerals as in FIGS. 1 to 14.

The embodiment shown in FIGS. 15 and 16 differs from the embodiment shown in FIGS. 1 to 14, in that it comprises a rail member 119 mounted on the elongate support member 19. The rail member 119 defines a central cylindrical guide channel 120, in which the transmission arrangement, generally designated 118, is provided. Each carrying member 14 includes an attaching element 114 to attach the carrying members 14 to the transmission arrangement. The rail member 119 defines an elongate opening 123 through which the attaching elements 114 extend for attachment to the transmission arrangement 118.

The transmission arrangement 118 is shown in more detail In FIG. 16, which is a close-up view of the region marked XV in FIG. 15. FIG. 16 shows two adjacent carrying members 14. The transmission arrangement 118 comprises a transmission means 121 connected to the two adjacent carrying members 14. The transmission arrangement 118 comprises a plurality of transmission means 121, whereby a respective transmission means 121 is provided for each pair of adjacent carrying members 14.

The transmission means 121 comprises a pulling member in the form of a pull rod 122 defining a threaded bore 124, having a downwardly facing opening. A bolt 126, having a head 126A, is received in the threaded bore 124 and extends downwardly therefrom. An outwardly extending member 128 is located between the head 126A and the pull rod 122. In the embodiment shown in FIGS. 15 and 16, the outwardly extending member 128 is in the form of a washer defining a central hole. The pull rod 122 is connected to the upper of the two adjacent carrying members 14.

The transmission means 121 further includes a receiving member 130 defining a receiving space 131, which, in the embodiment shown in FIGS. 15 and 16, is cylindrical. A reaction member 132 defining an aperture 134 is attached to the upper end of the receiving member 130. The pull rod 122 extends through the aperture 134 in the reaction member 132. The aperture 134 has a diameter that is less than the diameter of the central hole in the washer 128. The head 126A of the bolt 126 is received

The carrying members 14 can be lifted to their separated condition. During such lifting, the upper carrying member 14 of each pair of adjacent carrying members 14 lifts the pull rod 122 relative to the receiving member 130. When the outwardly extending member 128 engages the reaction member 132, the receiving member 130 and the lower carrying member 14 are lifted.

Thus, in substantially the same way as described above for the embodiment shown in FIGS. 1 to 14, the lifting of the upper most carrying member 14A, effects sequential lifting of each of the other carrying members 14.

In the embodiment shown in FIGS. 15 and 16, the lifting means (not shown in FIGS. 15 and 16) may comprise a single hydraulic ram which operates on a connecting member that extends between the adjacent arrays 12. Alternatively, the lifting means 16 may comprise two hydraulic rams, whereby each hydraulic ram can lift a respective array 12 of the carrying members 14.

There are thus described embodiments of two methods and an assembly which are particularly suitable for the mechanical handling of produce such as bacon logs or sides of bacon. These embodiments are more efficient and cause less damage to the produce than prior art handling methods. These embodiments also have the advantages described above.

FIGS. 17 to 26 show in more detail an example of a tray for use with the lifting apparatus 10 and for use in the method of use thereof described above. The tray shown in FIGS. 17 to 26 is generally designated 210. The tray 210 is suitable for holding products, such as meat products, for example logs of bacon, in a freezer.

The tray 210 comprises a main body 212 and a rim 214 extending around the main body 212. A skirt 215 surrounding the main body 212 extends downwardly from the periphery of the rim 214. The skirt 215 is configured so that opposite sides can be engaged by the carrying members 14, 14A of the lifting assembly 10, thereby allowing the trays to be supported by the carrying arrangements 12, 12A.

The main body 212 comprises a plurality of holding formations 216, which are arranged adjacent to one another and extend lengthwise across the tray 210.

Each of the holding formations 216 comprises a lower portion 218 and first and second wall portions 220, 222 which extend upwardly from the lower portion 218. As can be seen from FIG. 23, the first wall portion 220 extends from the lower portion 218 at a shallower angle than the second wall portion 222.

The first wall portion of each of the holding formation 216 is attached to the second wall portion of an adjacent holding formation 216 to define therebetween an air flow path 224. The first wall portion 220 defines a plurality of first air flow apertures 26 so that air flowing upwardly through the air path 224 passes out of the air flow aperture 226 and over an article held in the holding formation 216.

As can be seen from FIGS. 17 to 20, the lower portions 218 of each of the holding formations 216 define a plurality of second air flow apertures 228 extending across the holding formations 216.

The second air flow apertures 228 allow air to flow around a lower region of the article held on the holding formations 216.

Partition members 229 extend across each of the holding formation 216 substantially midway along the length thereof, thereby dividing each of the holding formations 216 into two so that two separate articles can be held in a single holding formation 216 but are kept separate from one another.

A plurality of support formations 230 extend downwardly from the rim 214. A plurality of corresponding locating members 232 extend upwardly from the rim in alignment with the support formations 230. A respective receiving aperture 236 is defined adjacent to each support formation 230, the purpose of which is explained below.

The support formations 230 allow a plurality of the trays 210 to be arranged in a stacked condition in a first orientation relative to each other, shown in FIGS. 21, 22 and 23. The trays 210 are arranged in the first orientation relative to each other, and the locating members 232 on each tray 210 are located in recesses 234 defined in the support formations 230 of the tray 210 directly above.

Thus, the trays 210 are held in the stacked condition by the cooperation of the support formations 230 of the trays 210 with the locating members 232 of each tray below. The support formations 230 of the lower most tray 210 can engage a pallet (not shown). If desired, the pallet can also be provided with locating members to locate the lowermost tray 210.

When the trays 210 are not in use, they can be arranged in a nested condition as shown in FIGS. 24, 25 and 26.

In order to arrange the trays 210 in the nested condition, the trays 210 are arranged in a second orientation relative to each other, in which every alternate tray 210 is rotated by 180° degrees relative to its position in the stacked condition. When the trays 210 are in the second orientation, the support members 232 of each tray 210 are aligned with the apertures 236 defined in the rim 214 of the tray 210 immediately below.

The correct positioning of the apertures 236 in the rim 214 allows the support formations 230 of each tray 210 to be received in the apertures 236 of the tray 210 immediately below, when the trays 210 are in the second orientation relative to one another so that they can be nested.

Also, when the trays 210 are in the nested condition, as shown more clearly in FIG. 26, the holding formations 216 of the trays 210 are received in the holding formations 216 of the tray 210 immediately below. Thus, the designers of the present invention have configured the support formations 230 relative to the apertures 236 and the holding formations 216 so that a plurality of the trays can be arranged in a nested condition, as shown, thereby taking up minimal room.

When the trays 210 are used with the lifting apparatus 10 described above, the support formations 230 can engage the support arrangements 106 of the rack 104, thereby allowing a plurality of the trays 210 to be supported on the rack 104. With the trays 210 disposed on the rack 104 in a freezing assembly, the trays 210 are spaced from each other, thereby allowing air to flow through the air flow apertures 226, and around the products on the tray 210, thereby ensuring efficient freezing.

Various modifications to the tray 210 can be made without departing from the scope of the invention.

1-58. (canceled)

59. A method of handling a load comprising a plurality of articles, wherein the method comprises: providing a lifting assembly comprising a plurality of carrying arrangements arranged one above another, the carrying arrangements being movable between proximate and separated conditions, whereby adjacent carrying arrangements are spaced from each other by a greater distance in the separated condition than in the proximate condition, wherein the lifting assembly further includes lifting means to apply a lifting force to the uppermost carrying arrangement and transmission means extending between adjacent carrying arrangements to transmit the lifting force from the uppermost carrying arrangement to each of the other carrying arrangements; disposing the articles on the carrying arrangements when the carrying arrangements are in the proximate condition; moving the carrying arrangements to the separated condition by operation of the lifting means, thereby moving the articles to a spaced configuration; and, with the carrying arrangements in the separated condition, delivering the articles to a support assembly to dispose the articles on the support assembly in the spaced configuration.

60. A method according to claim 59, wherein the support assembly is provided in a treatment assembly, and the method includes a treatment step after the articles have been disposed on the support assembly, wherein the treatment assembly comprises a freezing assembly to effect freezing of the articles and of the products held on the articles.

61. A method according to claim 59, wherein the step of moving the carrying arrangements to the separated condition comprises sequentially raising at least some of the carrying arrangements.

62. A method according to claim 59, wherein the carrying arrangements are arranged one above another, and the step of moving the carrying arrangements to the separated condition comprises raising the uppermost carrying arrangement, and thereafter sequentially raising at least some of the other carrying arrangements.

63. A method according to claim 59, wherein the support assembly has a plurality of support arrangements disposed one above another, each support arrangement being spaced from the, or each, adjacent support arrangement by a distance which is substantially equal to the distance between adjacent carrying arrangements when the carrying arrangements are in the separated condition and the step of disposing the articles on the support assembly comprises presenting the lifting assembly to the support assembly, and moving the lifting assembly to insert each carrying arrangement between adjacent support arrangements of the support assembly,

64. A method according to claim 59, including removing the articles from the support assembly by inserting respective carrying arrangements in the separated condition between adjacent support arrangements, wherein the articles are disposed on the carrying arrangements by moving the carrying arrangements upwardly relative to the support arrangements, thereby lifting the articles, and after the articles have been lifted from the support arrangements, the method includes removing the articles from the support assembly, and moving the carrying arrangements from the separated condition to the proximate condition.

65. A method according to claim 64, wherein the step of moving the carrying arrangements from the separated condition to the proximate condition comprises sequentially lowering at least some of the carrying arrangements.

66. A method of handling a load comprising a plurality of articles, wherein the method comprises: providing a lifting assembly comprising a plurality of carrying arrangements arranged one above another, the carrying arrangements being movable between proximate and separated conditions, whereby adjacent carrying arrangements are spaced from each other by a greater distance in the separated condition than in the proximate condition, wherein the lifting assembly further includes lifting means to apply a lifting force to the uppermost carrying arrangement and transmission means extending between adjacent carrying arrangements to transmit the lifting force from the uppermost carrying arrangement to each of the other carrying arrangements; providing a plurality of articles in a spaced configuration on a support assembly; and with the carrying arrangements in the separated condition, disposing the articles on the carrying arrangements; removing the articles from the support assembly; delivering the articles to a receiving means; and moving the carrying arrangements to the proximate condition to dispose the articles on the receiving means.

67. A method according to claim 66, Wherein the support assembly has a plurality of support arrangements disposed one above another, and each support arrangement is spaced from the, or each, adjacent support arrangement by a distance which is substantially equal to the distance between adjacent carrying arrangements when the carrying arrangements are in the separated condition, and the method includes inserting respective carrying arrangements between adjacent support arrangements.

68. A method according to claim 67, wherein after said carrying arrangements have been inserted between adjacent support arrangements, the articles are disposed on the carrying arrangements by moving the carrying arrangements upwardly relative to the support arrangements, thereby lifting the articles, and the step of removing the articles from the support assembly is effected after the articles have been lifted from the support arrangements,

69. A method according to claim 66, wherein the step of moving the carrying arrangements from the separated condition to the proximate condition comprises sequentially lowering at least some of the carrying arrangements.

70. A lifting assembly comprising a plurality of carrying arrangements arranged one above another, the carrying arrangements being movable between proximate and separated conditions, whereby adjacent carrying arrangements are spaced from each other by a greater distance in the separated condition than in the proximate condition, wherein the lifting assembly further includes lifting means for applying a lifting force to the carrying arrangements to lift the carrying arrangements, and a transmission arrangement for transmitting the lifting force to each of the carrying arrangements to move the carrying arrangements between the proximate and the separated conditions.

71. A lifting assembly according to claim 70, wherein the transmission arrangement comprises a plurality of transmission means, each transmission means being connected to adjacent carrying arrangements, and each transmission means comprising a first transmitting member connected to a first of the adjacent carrying arrangements, and a second transmitting member connected to a second of the adjacent earring arrangements.

72. A lifting assembly according to claim 71, wherein each transmission means is movable between a non-transmitting position, in which the adjacent carrying arrangements are in their proximate condition, and a transmitting position, in which the adjacent carrying arrangements are in their separated condition, and when each transmission means is in the transmitting position, each transmission means can transmit the lifting force from one of the adjacent carrying arrangements to the other of the adjacent carrying arrangements.

73. A lifting assembly according to claim 72, wherein the transmission means are arranged one above another, and when each transmission means is in the transmitting position, each transmission means can transmit the lifting force from the upper of the adjacent carrying arrangements to the lower of the adjacent carrying arrangements.

74. A lifting assembly according to claim 73, wherein each first transmitting member is pivotally connected to the first of the adjacent carrying arrangements, each second transmitting member is pivotally connected to the second of the adjacent carrying arrangements, and each of the first and second transmitting members is pivotally connected to each other, and wherein the first and second transmitting members are movable between flexed and extended positions, wherein when the adjacent carrying arrangements are in the proximate condition, the first and second transmitting members are in the flexed condition, and wherein when the adjacent carrying arrangements are in the separated condition, the first and second transmitting members are in the extended position.

75. A lifting assembly according to claim 74, wherein the first and second transmitting members of each transmission arrangement are slidable relative to each other.

76. A lifting assembly according to claim 75, wherein each first transmitting member comprises a pulling member connected to the first carrying arrangement for pulling said first carrying arrangement, and the first transmitting member includes an engaging member on the pulling member for engaging the second transmitting member and applying the lifting force thereto, and the first transmitting member further includes a fastener for fastening the engaging member to the pulling member.

77. A lifting assembly according to claim 76, wherein the engaging member comprises a radially outwardly extending member.

78. A lifting assembly according to claim 77, wherein the second transmitting member comprises a reaction member, which can he engaged by the engaging member to apply a reaction force thereto, the reaction member defining an aperture through which the pulling member extends, and wherein the engaging member engages the reaction member to apply said lifting force thereto when the transmission means is moved from non-transmitting position to the transmitting position.

79. A lifting assembly according to claim 70, wherein the lifting assembly comprises a support for supporting the carrying arrangements, the support comprising an upstanding elongate member, and the plurality of carrying arrangements comprising bearing means to engage the support.

80. A lifting assembly according to claim 70, wherein each carrying arrangement comprises two carrying members, and the lifting assembly comprise two arrays of the carrying members, each array comprising a plurality of the carrying members movable between the proximate and separated conditions.

81. A lifting assembly according to claim 80, wherein the carrying members of each array are arranged substantially vertically, one above another, and wherein the arrays are arranged side by side to provide a plurality of pairs of carrying members, wherein the carrying members of each pair are disposed to carry a respective article between them.
